(19) United States
(12) Patent Application Publication
(10) Pub. No.: US 2011/0307427 A1
(43) Pub. Date: Dec. 15, 2011

(54) Molecular markers predicting response to adjuvant therapy, or disease progression, in breast cancer

(76) Inventors: Steven Linke, Carlsbad, CA (US); Troy Bremer, (US); Comelius Diamond, (US)

(21) Appl. No.: 13/199,068

(22) Filed: Aug. 18, 2011

Related U.S. Application Data
(63) Continuation-in-part of application No. 11/787,518, filed on Apr. 17, 2007, now abandoned.
Application No. 11/787,518 is a continuation-in-part of application No. 11/407,169, filed on Apr. 18, 2006, now abandoned.
(60) Provisional application No. 60/673,223, filed on Apr. 19, 2005.
(60) Provisional application No. 61/402,317, filed on Aug. 27, 2010.

(51) Int. Cl. G06N 5/02; G06F 15/18

(52) U.S. Cl. 706/12; 706/52

(57) ABSTRACT

Predicting response to adjuvant therapy or predicting disease progression in breast cancer is realized by (1) first obtaining a breast cancer test sample from a subject; (2) second obtaining clinicopathological data from said breast cancer test sample; (3) analyzing the obtained breast cancer test sample for presence or amount of (a) one or more molecular markers of hormone receptor status, one or more growth factor receptor markers, (b) one or more tumor suppression/apoptosis molecular markers; and (c) one or more additional molecular markers both proteomic and non-proteomic that are indicative of breast cancer disease processes; and then (4) correlating (a) the presence or amount of said molecular markers and, with (b) clinicopathological data from said tissue sample other than the molecular markers of breast cancer disease processes. A kit of (1) a panel of antibodies; (2) one or more gene amplification assays; (3) first reagents to assist said antibodies with binding to tumor samples; (4) second reagents to assist in determining gene amplification; permits, when applied to a breast cancer patient's tumor tissue sample, (A) permits observation, and determination, of a numerical level of expression of each individual antibody, and gene amplification; whereupon (B) a computer algorithm, residing on a computer can calculate a prediction of treatment outcome for a specific treatment for breast cancer, or future risk of breast cancer progression.

### REFERENCE TO RELATED PATENT APPLICATIONS

The present application is a continuation-in-part of U.S. patent application Ser. No. 11/787,518 which is a continuation-in-part of U.S. patent application Ser. No. 11/407,169 which is descended from, and claims benefit of priority of, U.S. provisional patent application Ser. No. 60/673,223, filed Apr. 19, 2005, which applications are hereby incorporated by reference in their entireties.

The present application also claims benefit of priority of U.S. provisional patent application Ser. No. 61/402,317 filed Aug. 27, 2010, having the identical name, and to the identical inventors, as does the present application.

### GOVERNMENT SUPPORT

The present invention was developed under Research Support of the National Science Foundation, Award #0611297. The U.S. Government may have certain rights in this invention.

### BACKGROUND OF THE INVENTION

1. Field of the Invention

The present invention generally concerns molecular markers for the prediction of response to adjuvant therapy or disease progression, in breast cancer.

2. Background of the Invention

### 2.1 Breast Cancer Therapy

After surgical removal of their primary tumors, breast cancer patients with operable stage I-III tumors must decide whether to receive adjuvant systemic treatment, such as hormone therapy and/or cytotoxic chemotherapy, to help minimize their chance of recurrence. Currently, these decisions are aided by a variety of published clinical practice guidelines, including the National Institutes of Health Consensus Statement, the National Comprehensive Cancer Network Clinical Practice Guidelines in Oncology™, the Ninth St. Gallen Conference Consensus, the Nottingham Prognostic Index (NPI), and Adjuvant! Online (Adjuvant!).

Unfortunately, the accuracy of these guidelines is limited, because they are based largely on general clinicopathologic data, such as tumor size and grade. For example, approximately 80-95% of patients would be recommended to receive cytotoxic chemotherapy according to the guidelines, yet only ˜25% would have recurrences without it, and only ˜5% exhibit a direct benefit⁶. This over-treatment leads to unnecessary side effects in both the short-term (e.g, cytopenia, nausea, and blood clots) and long-term (e.g., cardiotoxicity and neurological problems)⁷⁻¹¹. In addition, in spite of the conservative nature of the guidelines, some non-chemotherapy-treated low-risk patients end up suffering recurrences, indicating possible under-treatment. Thus, there is an established need for more accurate individualized guidance.

### 2.2 Molecular Markers Providing Guidance in Breast Cancer Therapy

In the last few years, multi-marker tests have become available to provide guidance, such as Agendia's MammaPrint®, Genomic Health's Oncotype DX™, and Prediction Sciences's Insight Dx™ tests (see Linke et al: A multi-marker model to predict outcome in tamoxifen-treated breast cancer patients. Clin Cancer Res 12:1175-1183, 2006 and U.S. patent application Ser. Nos. 11/407,169 and 11/787,518, henceforth “current Insight Dx™ profile”). The first two are gene expression-based and can be considered first- and second-generation tests. The latter uses the expression of seven proteins to produce its prognostic profile. Although direct comparisons cannot be made, because no head-to-head studies are available, performance measures such as hazard ratios and sensitivity/specificity analyses indicate that the clinical performance of Oncotype DX™ is somewhat superior to that of MammaPrint®, and preliminary validation data from the current Insight Dx™ profile indicates that it will have a clinical performance that matches or exceeds Oncotype DX™. In addition, the Insight Dx™ profile applies to a wider set of operable stage I-III patients, including those who are node-positive, as well as those who are considering either no adjuvant treatment or hormone therapy only. Furthermore, the current Insight Dx™ profile does not have an intermediate risk region where no clinical decision, e.g. whether or not to receive chemotherapy, is given.

The current Insight Dx™ profile has a limitation in that markers that determine tumor invasiveness into the surrounding tissue are not represented. These markers are important in determining the future progression of the tumor, and play a role in proliferation and metastasis of the tumor. In a previous application, we have show the role of several of these markers (p27, MTA1, TIMP1, uPa) have in adding to the value of the current Insight Dx™ profile. We now show in the instant invention the ability of Caveolin-1 to increase the performance of current Insight Dx™ profile, and to predict ductal carcinoma in-situ type-cancers.

CDKN1B, also known as p27^{Kip1}, plays an anti-proliferative role carried out through inhibition of G1 cell cycle phase cyclin-dependent kinases. Although not all published reports in breast cancer show a statistically significant role, a preponderance of studies indicate that high levels of nuclear CDKN1B are associated with better prognosis and/or response to therapy (extensively reviewed in Alkarain A, Jordan R, Slingerland J: p27 deregulation in breast cancer: prognostic significance and implications for therapy. J Mammary Gland Biol Neoplasia 9:67-80, 2004 and Colozza M, et al: Proliferative markers as prognostic and predictive tools in early breast cancer: where are we now? Ann Oncol 16:1723-39, 2005). Similar to the new clinicopathologic features, CDKN1B was an independent linear factor (i.e., it did not interact to any large extent with the other features, indicating that it is in a distinct pathway, perhaps related to cell cycle).

MTA1, or “metastasis-associated 1” was originally identified as being over-expressed in metastatic rat mammary carcinoma cell lines in a differential screen with non-metastatic cells (Toh Y, Pencil S D, Nicolson G L: A novel candidate metastasis-associated gene, mta1, differentially expressed in highly metastatic mammary adenocarcinoma cell lines. cDNA cloning, expression, and protein analyses. J Biol Chem 269:22958-63, 1994). Subsequently, it was identified as an ER co-repressor that inhibits estrogen-induced transcription of genes with ER element-responsive promoters, perhaps through acetylation-dependent modulation of chromatin structure (Mazumdar A, et al: Transcriptional repression of oestrogen receptor by metastasis-associated protein 1 corepressor. Nat Cell Biol 3:30-7, 2001). Thus, the interaction we observed in this study with the hormone receptor pathway is not surprising. Most preliminary reports of MTA1 suggest that high levels are logically associated with worse prognosis. However, MTA1 is complicated in that it can be found in different isoforms in different cellular compartments and in different cell types, including normal epithelium, tumor cells, and stromal cells (Acconcia F, Kumar R: Signaling regulation of genomic and nongenomic functions of estrogen receptors. Cancer Lett 238:1-14, 2006). More recent reports indicate that it may be indicative of local invasion and lymph node metastasis, but not necessarily distant metastasis, and that tumors with the highest levels of MTA1 rarely undergo distant metastasis (Hofer M D, et al: Comprehensive analysis of the expression of the metastasis-associated gene 1 in human neoplastic tissue. Arch Pathol Lab Med 130:989-96, 2006). In fact, evidence indicates that elevated MTA1 sensitizes breast tumors to systemic therapies, such as tamoxifen (Martin M D, et al: Breast tumors that overexpress nuclear metastasis-associated 1 (MTA1) protein have high recurrence risks but enhanced responses to systemic therapies. Breast Cancer Res Treat 95:7-12, 2006). Furthermore, in prostate cancer (also a hormone-regulated disease), elevated MTA1 is associated with less frequent prostate specific antigen (PSA) recurrence after radical prostatectomy (Hofer M D, et al: The role of metastasis-associated protein 1 in prostate cancer progression. Cancer Res 64:825-9, 2004). The complex nature of the staining and interactions exhibited by this marker make it an excellent candidate for the IHC- and machine learning-based methodologies used in this continuing study.

TIMP1 is a member of a family of tissue inhibitors of matrix metalloproteinases (MMPs). The MMPs are a group of peptidases that degrade extracellular matrix (ECM), so elevated expression of their inhibitors, such as TIMP1, is expected to reduce invasiveness. Consistent with this hypothesis and with the findings of our study, overexpression of TIMP1 in breast carcinoma cells in vitro decreases their invasiveness (see for instance Dien J, et al: Signal transducers and activators of transcription-3 up-regulates tissue inhibitor of metalloproteinase-1 expression and decreases invasiveness of breast cancer. Am J Pathol 169:633-42, 2006), and elevated levels of TIMP1 assessed by IHC in breast tumors is associated with better prognosis (see for instance Nakopoulou L, et al: The favorable prognostic impact of tissue inhibitor of matrix metalloproteinases-1 protein overexpression in breast cancer cells. Apmis 111:1027-36, 2003).

PLAU, also known as uPA or urokinase plasminogen activator, is a serine protease that is involved in the degradation of ECM as a member of the plasminogen activation system (PAS) pathway. The proteolytic activity of proteins in the plasminogen activation system (PAS) can degrade ECM either directly or through activation of matrix metalloproteinases (MMPs). In fact, MMP function may require PAS factors to enable intravasation (see for instance Kim J, Yu W, Kovalski K, Ossowski L: Requirement for specific proteases in cancer cell intravasation as revealed by a novel semiquantitative PCR-based assay. Cell 94:353-62, 1998), so the use of PAS components as tumor markers may be superior to MMPs. Other PAS proteins include PLAU's cell surface-associated receptor PLAUR (uPAR) (see for instance Andreasen P A, Kjoller L, Christensen L, Duffy M J: The urokinase-type plasminogen activator system in cancer metastasis: a review. Int J Cancer 72:1-22, 1997 and Schmitt M et al: Clinical impact of the plasminogen activation system in tumor invasion and metastasis: prognostic relevance and target for therapy. Thromb Haemost 78:285-96, 1997), as well as at least two of its inhibitors, SERPINE1 (PAI-1) and SERPINB2 (PAI-2).

In recent years, it has become increasing apparent that stromal components in the tumor microenvironment, including the extracellular matrix and cell types including fibroblasts, vascular endothelial cells, immune and inflammatory cells, have a profound influence on the growth and metastasis of tumors. The molecular cross talk between tumor cells and these stromal elements plays an important role in defining the phenotype of a tumor. (Bissell M J, Radisky D. Putting tumors in context. Nature Reviews (Cancer). 2001; 1:1-19) Tumor cells can trigger the deposition of a reactive stroma or desmoplasia containing activated fibroblasts, connective tissue, immune and inflammatory cells that may favor invasion and metastasis of the cancer. (Mueller M M, Fusenig N E. Friends or foes—bipolar effects of the tumour stroma in cancer. Nat Rev Cancer. 2004; 4:839-849) Many cell types in the mammary stroma express caveolin-1. However the role of this protein in molecular cross talk between tumor and stromal cells remains unknown.

Caveolin-1 is an integral plasma membrane protein that resides in specialized lipid rafts called caveolae in terminally differentiated mesenchymal cells including adipocytes, endothelial cells, and fibroblasts. (Parton R G, Hanzal-Bayer M, Hancock J F. Biogenesis of caveolae: a structural model for caveolin-induced domain formation. J Cell Sci. 2006; 119:787-796) Within caveolae, the bilayer of cholesterol and sphingolipids is in an ordered state that restricts the movement of lipids. Caveolin-1 interacts directly with, and organizes cholesterol within caveolae. (Murata M, Peranen J, Schreiner R, Wieland F, Kurzchalia T V, Simons K. VIP21/caveolin is a cholesterol-binding protein. Proc Natl Acad Sci USA. 1995; 92:10339-10343) Various receptors and signaling molecules are localized within caveolae, and caveolin-1 interacts with and negatively regulates a number of these through its scaffolding domain. (Sargiacomo M, Scherer P E, Tang Z, Kubler E, Song K S, Sanders M C, et al. Oligomeric structure of caveolin: implications for caveolae membrane organization. Proc Natl Acad Sci USA. 1995; 92:9407-9411) By ordering lipids and concentrating signaling molecules, caveolae may facilitate cross talk between signaling pathways. Caveolin-1 is also found in the cytosol and has a role in lipid homeostasis and transport. (Sargiacomo M, Scherer P E, Tang Z, Kubler E, Song K S, Sanders M C, et al. Oligomeric structure of caveolin: implications for caveolae membrane organization. Proc Natl Acad Sci USA. 1995; 92:9407-9411)

Caveolin-1 is localized to human chromosome 7q31.1, a site that exhibits loss of heterozygosity in a range of tumor types. (Zenklusen J C, Bieche I, Lidereau R, Conti C J. (C-A)n microsatellite repeat D7S522 is the most commonly deleted region in human primary breast cancer. Proc Natl Acad Sci USA. 1994; 91:12155-12158) However, the role of caveolin-1 in breast cancer remains unclear. Earlier reports that caveolin-1 is expressed in normal breast epithelium (Engelman J A, Lee R J, Karnezis A, Bearss D J, Webster M, Siegel P, et al. Reciprocal regulation of neu tyrosine kinase activity and caveolin-1 protein expression in vitro and in vivo. Implications for human breast cancer. J Biol Chem.) are contradicted by more recent studies that found that its expression is associated with the myoepithelium and other tissues of mesenchymal origin and not with normal luminal epithelium. (Savage K, Lambros M B, Robertson D, Jones R L, Jones C, Mackay A, et al. Caveolin 1 is overexpressed and amplified in a subset of basal-like and metaplastic breast carcinomas: a morphologic, ultrastructural, immunohistochemical, and in situ hybridization analysis. Clin Cancer Res. 2007; 13:90-101) A number of studies have reported that caveolin-1 is down-regulated in breast cancers compared with normal mammary tissue. (Chen S T, Lin S Y, Yeh K T, Kuo S J, Chan W L, Chu Y P, et al. Mutational, epigenetic and expressional analyses of caveolin-1 gene in breast cancers. Int J Mol Med. 2004; 14:577-582) Similarly, caveolin-1 was absent in 10 invasive breast carcinomas, but present in two breast tumors of myoepithelial origin (basal-like cancers). (Hurlstone A F, Reid G, Reeves J R, Fraser J, Strathdee G, Rahilly M, et al. Analysis of the Caveolin-1 gene at human chromosome 7q31.1 in primary tumours and tumour-derived cell lines. Oncogene. 1999; 18:1881-1890) Down-regulation of caveolin-1 may be due to inactivating mutations in the gene, as reported previously, (Hayashi K, Matsuda S, Machida K, Yamamoto T, Fukuda Y, Nimura Y, et al. Invasion activating caveolin-1 mutation in human scirrhous breast cancers. Cancer Res. 2001; 61:2361-2364) but not confirmed in another study. (Chen S T, Lin S Y, Yeh K T, Kuo S J, Chan W L, Chu Y P, et al. Mutational, epigenetic and expressional analyses of caveolin-1 gene in breast cancers. Int J Mol Med. 2004; 14:577-582) Caveolin-1 gene expression may also be regulated in breast cancer through methylation. New data demonstrate that high caveolin-1 expression in tumor epithelium is associated with basal, metaplastic, and triple negative breast cancers (negative for estrogen receptor [ER], progesterone receptor [PR], and Her2), as well as with inflammatory breast cancers. (Elsheikh S E, Green A R, Rakha E A, Samaka R M, Ammar A A, Powe D, et al. Caveolin 1 and caveolin 2 are associated with breast cancer basal-like and triple-negative immunophenotype. Br J Cancer. 2008; 99:327-334) The role of caveolin-1 in other tumor types appears to be varied, with expression associated with cancer suppression in ovarian, small cell lung, and colon cancers, (Wiechen K, Diatchenko L, Agoulnik A, Scharff K M, Schober H, Arlt K, et al. Caveolin-1 is down-regulated in human ovarian carcinoma and acts as a candidate tumor suppressor gene. Am J Pathol. 2001; 159:1635-1643; Sunaga N, Miyajima K, Suzuki M, Sato M, White M A, Ramirez R D, et al. Different roles for caveolin-1 in the development of non-small cell lung cancer versus small cell lung cancer. Cancer Res. 2004; 64:4277-4285; Bender F C, Reymond M A, Bron C, Quest A F. Caveolin-1 levels are down-regulated in human colon tumors, and ectopic expression of caveolin-1 in colon carcinoma cell lines reduces cell tumorigenicity. Cancer Res. 2000; 60:5870-5878) but with cancer progression in prostate, non-small cell lung, esophageal, and colon cancers. (Karam J A, Lotan Y, Roehrborn C G, Ashfaq R, Karakiewicz P I, Shariat S F. Caveolin-1 overexpression is associated with aggressive prostate cancer recurrence. Prostate. 2007; 67:614-622)

The instant invention is the first to show that high levels of stromal CAV1 were associated with worse patient outcome. This is in contrast to previous findings by the Michael Lisanti and Robin Anderson (Molecular profiling of a lethal tumor microenvironment, as defined by stromal caveolin-1 status in breast cancers. Witkiewicz A K, Lisanti M P. et al. Cell Cycle. 2011 Jun. 1; 10(11):1794-809.; Erica K. Sloan, Robin L. Anderson, et al. Stromal Cell Expression of Caveolin-1 Predicts Outcome in Breast Cancer, Am. J. Path., Vol. 174, No. 6, June 2009) groups, in which high levels of stromal CAV1 were associated with better patient outcome.

This result has recently been confirmed by the Goetz group (Biomechanical Remodeling of the Microenvironment by Stromal Caveolin-1 Favors Tumor Invasion and Metastasis Jacky G. Goetz et al. J. Cell. 2011.05.040). They Goetz group theorizes that the worse prognosis has something to do with CAV1 being involved in aligning collagen fibers in such a way that enables invasion and metastasis of the tumor cells.

### SUMMARY OF THE INVENTION

The present invention is embodied in (1) a method of predicting response to adjuvant therapy or predicting disease progression in breast cancer; and (2) a kit consisting of a panel of antibodies the binding of which with breast cancer tumor samples has been correlated with breast cancer treatment outcome or patient prognosis.

### 1. A Method of Predicting Response to Adjuvant Therapy or Predicting Disease Progression in Breast Cancer

In one of its aspects the present invention is embodied in a method of predicting response to adjuvant therapy or predicting disease progression in breast cancer.

In the method a breast cancer test sample is first obtained from a subject, and then clinicopathological data such as tumor size, grade, and nodal status is obtained from this breast cancer test sample and patient.

The obtained breast cancer test sample is analyzed for presence or amount of (1) one or more molecular markers of hormone receptor status, one or more growth factor receptor markers, and one or more tumor suppression/apoptosis molecular markers; (2) one or more additional molecular markers both proteomic and non-proteomic that are indicative of breast cancer disease processes consisting essentially of the group consisting of: angiogenesis, apoptosis, catenin/cadherin proliferation/differentiation, cell cycle processes, cell surface processes, cell-cell interaction, cell migration, centrosomal processes, cellular adhesion, cellular proliferation, cellular metastasis, invasion, cytoskeletal processes, ERBB2 interactions, estrogen co-receptors, growth factors and receptors, membrane/integrin/signal transduction, metastasis, oncogenes, proliferation, proliferation oncogenes, signal transduction, surface antigens and transcription factor molecular markers.

Finally, (1) the presence or amount of said molecular markers and, is correlated with (2), clinicopathological data from said tissue sample other than the molecular markers of breast cancer disease processes, in order to deduce a probability of response to adjuvant therapy or future risk of disease progression in breast cancer for the subject.

2. A Kit Consisting of a Panel of Antibodies the Binding of which with Breast Cancer Tumor Samples has been Correlated with Breast Cancer Treatment Outcome or Patient Prognosis

In another of its embodiments the present invention is contained in a kit consisting of a panel of antibodies the binding of which with breast cancer tumor samples has been correlated with breast cancer treatment outcome or patient prognosis.

The kit includes a panel of antibodies the binding of which with breast cancer tumor samples has been correlated with breast cancer treatment outcome or patient prognosis, said antibodies being described in the instant specification; one or more gene amplification assays corresponding to genes described in the instant specification, an amplification of which genes has been correlated with breast cancer treatment outcome or patient prognosis or both treatment outcome or patient prognosis; first reagents to assist said antibodies with binding to tumor samples; and second reagents to assist in determining gene amplification for said genes the amplification of which genes has been correlated.

In this the panel of antibodies, the one or more gene amplification assays, the first reagents and the second reagents can be applied to a breast cancer patient's tumor tissue sample; whereupon the application of said reagents and assays permits observation, and determination, of a numerical level of expression of each individual antibody, and gene amplification, upon the breast cancer patient's tumor tissue sample.

Furthermore, a computer algorithm, residing on a computer, can calculate in consideration of determined levels of expression for antibodies and the amplified genes—in addition to previously-provided clinicopathological information on the breast cancer sample and patient—a prediction of treatment outcome for a specific treatment for breast cancer, or future risk of breast cancer progression, or both specific treatment and future risk of breast cancer progression, for the patient from whom the breast cancer tumor sample was obtained

### BRIEF DESCRIPTION OF THE DRAWINGS

FIG. 1 is a Table showing a Cox proportional hazards analysis.

FIG. 2 is a Table 1 showing RPH patient characteristics.

FIG. 3 is three graphs showing validation of Insight Dx Breast Cancer Profile

FIG. 4 is two graphs showing an Insight Dx Breast Cancer Profile compared to Adjuvant! Online

FIG. 5 is three graphs showing that Addition of CDKN1B to Insight Dx shows chemotherapy benefit.

FIG. 6 is a graph showing that Stromal CAV1 shows strong univariate prognostic significance in RPH data set.

FIG. 7 is two graphs showing that Stromal CAV1 further stratifies Insight Dx high- and low-risk patients

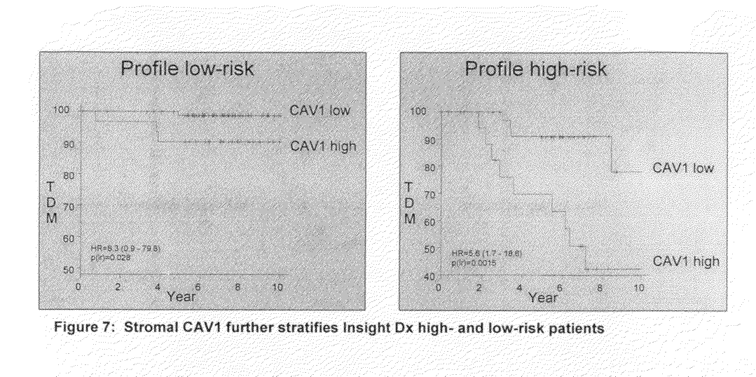

### DESCRIPTION OF THE PREFERRED EMBODIMENT

### 1. The Preferred Embodiment of the Instant Invention

To clarify the relationship between and breast cancer progression or suppression, we have analyzed tissue sections specifically for stromal and tumor epithelial cell expression of caveolin-1 from a cohorts of 550 breast cancer patients. Approximately 90 of the patients were originally diagnosed with DCIS or mixed DCIS and LCIS breast carcinomas.

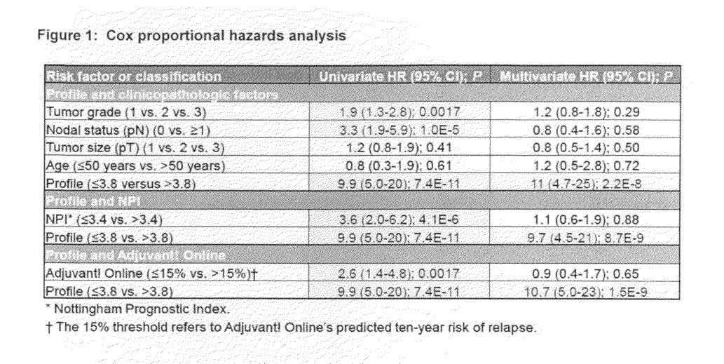

Tissue microarray slides that contain tumor cores from a total of approximately 550 breast cancer patients with associated clinicopathologic, treatment, and outcome data were obtained from the Royal Perth Hospital (RPH) in Perth, Western Australia. After the RPH samples were stained and scored, and algorithms trained on the combined UHB and IPC patients sets (see Linke et al: A multi-marker model to predict outcome in tamoxifen-treated breast cancer patients. Clin Cancer Res 12:1175-1183, 2006 and U.S. patent application Ser. Nos. 11/407,169 and 11/787,518) were used to assign risk scores to all stage I-IIIA patients in all three patient sets on a scale of 0 to 10+. A pre-determined risk score threshold of 3.8 was used to separate patients into low and high risk groups. We validated the Insight Dx™ Breast Cancer Profile in these patients. The patient characteristics are given in Table 1, and a Cox proportional analysis of risk factors is given in FIG. 1.

We used assay development based on GMP reagents and stained said tumor cores on clinically validated platforms. The scoring was by board-certified pathologists, and the risk scoring was given by the non-linear Insight Dx™ algorithm.

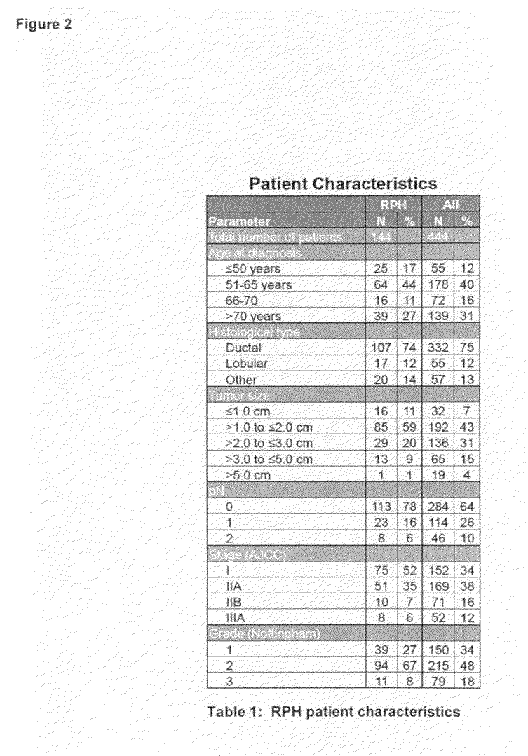

Results of the validation is given in FIGS. 2a-c. In FIGS. 2a and 2b, it is shown that in a Kaplan-Meier survival analysis, the profile performs well in both the validation set as well as all three sets grouped together. Furthermore, in FIG. 1c, it is shown that a continuous risk curve can be generated, allowing the test to give more than a binary decision when generating a risk profile to an individual patient, allowing the physician more leeway in evaluating this decision aid.

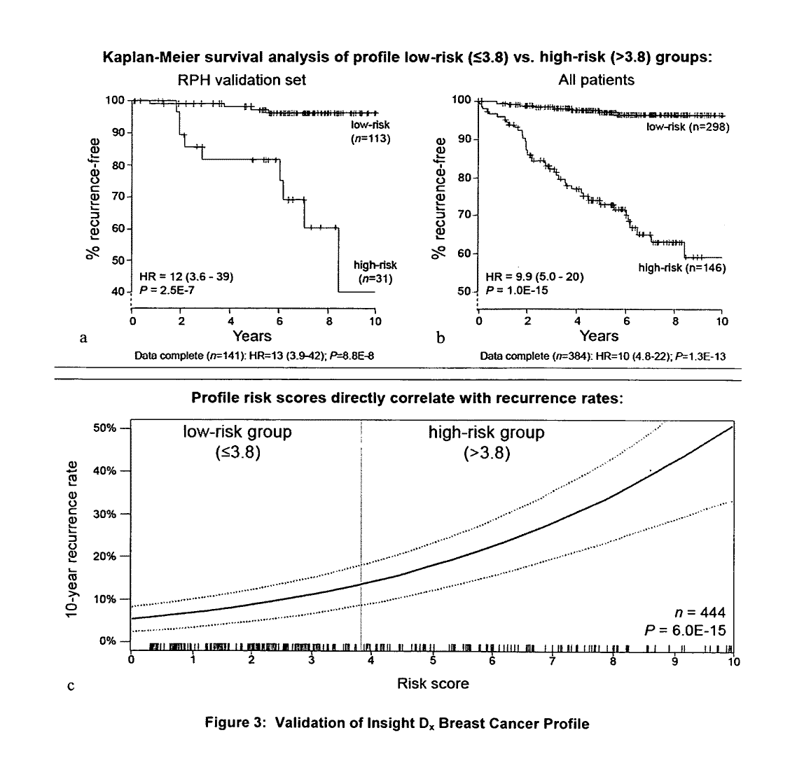

In evaluating the test against other commonly-used clinical tools, the Insight Dx™ Breast Cancer Profile performs well. In FIG. 3 we compare the test versus the well-known Adjuvant! Online risk score. In both Adjuvant! Online's high risk (FIG. 3a) and low-risk (FIG. 3b) classification, the Insight Dx™ Breast Cancer Profile was able to further stratify the patient groups, e.g. finding a low-risk population in Adjuvant! Online's high-risk group that would ordinary receive chemotherapy and thus would be spared this treatment, and a high-risk group in Adjuvant! Online's low-risk population, thus in this case the profile would recommend that the patient have more aggressive treatment options to prevent recurrence of the cancer.

### 2. Discussion of the Preferred Embodiment of the Instant Invention

In designing the new version of the test eight markers were selected to study: TIMP1, PLAU/uPA, MTA1, CDKN1B, Ki-67, CAV-1 (tumor), and CAV-1 (stromal). Most of these markers are in tumor metastasis and invasion pathways, as opposed to the original test, which focused on biological pathways critical to tumor progression, including hormone receptor-based growth, other growth factors, cell cycle, apoptosis, and proliferation. The three molecular markers: MTA1, PLAU/uPA, CDKN1B, and TIMP1 were available for study previously in the IPC dataset (previously described in U.S. patent application Ser. No. 11/787,518), where they showed statistical contributions to progression independent of the core profile.

The PLAU/uPA marker was dropped due to difficulty getting the antibody to work, and the Ki-67 marker is only to be used in the new profile to differentiate between grades 2 and 3, e.g. a high expression of Ki-67 would add one point to a tumor grade for input into the algorithm, making a grade of 2 into a grade of 3, for instance. The RPH set was used again with the new markers, as data had already been collected for the Insight Dx™ Breast Cancer Profile.

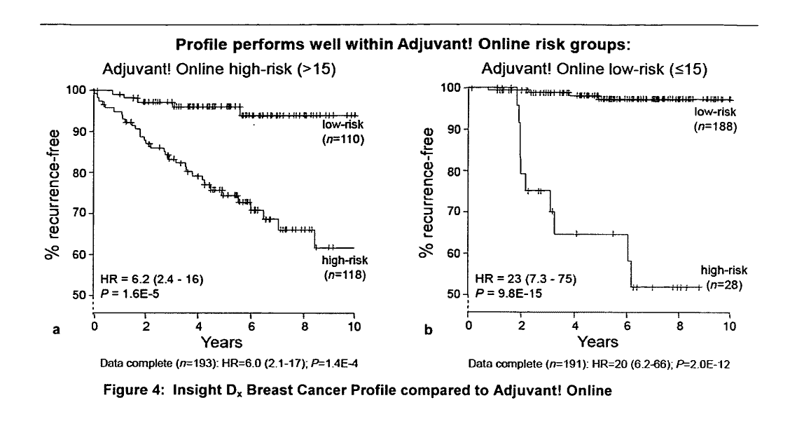

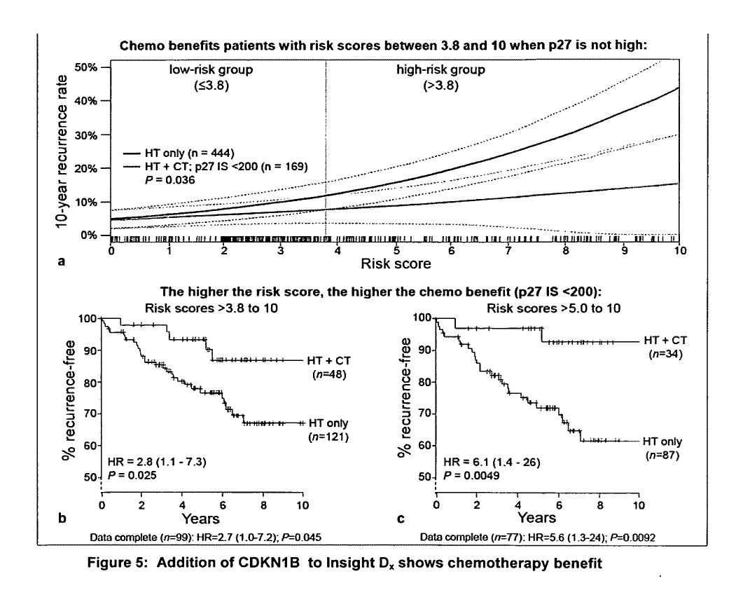

It was found that two markers augmented the power of the Insight Dx™ Breast Cancer Profile, CDKN1 B and CAV-1, the latter scored in stromal tissue. A second profile was generated with the addition of CDKN1B to the original Insight Dx™ Breast Cancer Profile, and the addition of this marker allowed the profile to show chemotherapy benefit. This is shown in FIG. 4. Further analysis of patients treated with cytotoxic chemotherapy in addition to hormone therapy showed that the survival benefit of chemotherapy was significantly higher in the smaller subset of patients identified as high-risk by such profiles, in comparison to high-risk populations identified by clinical practice guidelines (FIG. 4a). Interestingly, there was no observable chemotherapy benefit in profile low-risk patients, but there was substantial benefit in profile high-risk patients (FIGS. 4b,c). The magnitude of the profile risk scores correlated with the likelihood of a metastasis or death, so different or multiple thresholds could be used to define different risk categories, depending on individual tolerance for risk. Alternatively, the risk scores could be used as continuous functions to predict events without defining specific risk categories.

[MTA1, TIMP1, and CAV1 were individually assessed for prognostic significance both independent of, and in combination with, the Insight Dx™ Breast Cancer Profile. MTA1 and TIMP1 (in tumor cells) both showed a weak prognostic trend, but it was not statistically significant. This trend was enhanced slightly when the two markers were combined, but again did not reach a significant effect to warrant an inclusion into an improved version of the test. CAV1 as measured in tumor cells did not have any prognostic significance on its own. However, CAV1 as measured in stromal cells did have a strong independent prognostic effect, as shown in FIG. 5.

The staining of the marker was assessed in stromal fibroblasts surrounding tumor epithelial cells, hence the name stromal CAV1. The data set consisted of hormone receptor-positive patients treated with anti-hormone therapy with and without the addition of chemotherapy. The outcome was time to distant metastasis (TDM).

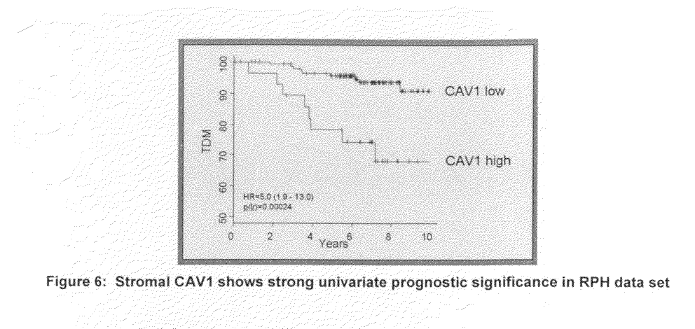

In FIG. 6, we can see that the addition of stromal CAV1 to the Insight Dx™ Breast Cancer Profile further stratified the patient population. In the profile low-risk group, patients with high stromal CAV1 expression had about a 10% worse outcome at 10 years (defined again as TDM) than patients who had low stromal CAV1 expression. Committantly, in the Insight Dx™ Breast Cancer Profile high-risk group, patients who had low stromal CAV1 expression had about a 40% chance of not having a distant metastasis than those patients who had high stromal CAV1 expression.

Finally, CAV1 expression was in 85% of the ductal carcinoma in-situ (DCIS) population, as compared to the lobular carcinoma in-situ (LCIS) population, where it showed up only in 10% of this population, thus the conclusion is that this is a good marker to predict DCIS.

### 3. Recapitulation of the Instant Invention

Breast cancer is the most common malignancy in Western women, and it is second only to lung cancer as the most common cause of cancer death. It affects millions of women worldwide. The current standard to decide on therapy is ER/PGR/ERBB2 status, but up to half of patients fail to respond. Recent gene-expression based tests do not accurately reflect the tumor microenvironment and do not incorporate clinicopathological factors as well. Accurate treatment outcome prediction arising from an improved version of the Insight Dx assay as described in the instant invention would guide patients to the most biologically and cost effective treatments in a timely fashion.

Historically patient data has been gathered in a series of immunohistochemical stains and/or fluorescent in situ hybridizations and/or other methods of molecular marker elucidation in a breast cancer patient's tumour and/or other tissue. In accordance with the present invention, the data gathered from these investigations was subjected to statistical analysis in combination with the patient's clinical and pathological data. The analysis is directed to revealing the patient's likelihood of suffering a recurrence of the cancer and/or other adverse events. Pathological data analysed included such features as the pathological status of the primary tumour and lymph nodes, the histological type and grade of the tumour cells, etc.

Thus the multivariate model of the present invention predicts outcomes based on statistically significant contributions of clinicopathological features and several molecular markers: ER, PGR, ERBB2/HER-2, EGFR, BCL-2, TP-53, CDKN1B/p-27, CAV-1 (stromal) and c-MYC/8q24 gene amplification, among others.

The present invention will thus be realized to provide at least three separate and different insights, though not limited by such, as claimed below.

For example, the primary insight of the invention can be expressed by the statement: “Ms. Patient, the aggressiveness of your breast cancer tumor is derived from considering a set of biomarkers in combination with tumor size, grade, and histological type, and these biomarkers are the protein expression values of ER, PGR, BCL-2, ERBB2/HER-2, EGFR, CDKN1B/p-27, CAV-1, and TP-53, and c-MYC gene amplification, interpolated by an algorithm. Your personal probability of survival with adjuvant therapy only or without any therapy at all may be seen on this graph accompanying your test results.”

The secondary aspect of the invention can be expressed, by way of example, in the statement: “Ms. Patient, if you chose an adjuvant chemotherapy in addition to a treatment of endocrine therapy, your personal probability of survival may be seen on this graph accompanying your test results.”

The tertiary aspect of the invention can be expressed, by way of example, in the statement: “Ms. Patient, given that considering said biomarker panel has given you a low chance of long-term survival from your breast cancer using current treatment, you may want to consider a more aggressive course of treatment, including first-line use of an adjuvant targeted therapy in conjuction with or instead of said current treatment protocol, including investigational therapies.”

The quaternary aspect of the invention can be expressed as using high stromal CAV-1 expression as a marker of DCIS, by itself or in conjunction with other markers.

The quintenary aspect of the invention can be expressed as producing a monoclonal antibody to block the expression of, or modulate the expression of, CAV-1 in the stromal part of the cell, thereby restricting tumor growth and/or invasiveness into surrounding tissue.

In accordance with these and still other insights obtained by the building, and the exercise, of the diagnostic test model in accordance with the present invention, the invention should be broadly defined by the following claims.

We claim:

1. A method of predicting response to adjuvant therapy or predicting disease progression in breast cancer, the method comprising:
first obtaining a breast cancer test sample from a subject;
second obtaining clinicopathological data from said breast cancer test sample;
analyzing the obtained breast cancer test sample for presence or amount of (1) one or more molecular markers of hormone receptor status, one or more growth factor receptor markers, and one or more tumor suppression/apoptosis molecular markers; (2) one or more additional molecular markers both proteomic and non-proteomic that are indicative of breast cancer disease processes consisting essentially of the group consisting of: angiogenesis, apoptosis, catenin/cadherin proliferation/differentiation, cell cycle processes, cell surface processes, cell-cell interaction, cell migration, centrosomal processes, cellular adhesion, cellular proliferation, cellular metastasis, invasion, cytoskeletal processes, ERBB2 interactions, estrogen co-receptors, growth factors and receptors, membrane/integrin/signal transduction, metastasis, oncogenes, proliferation, proliferation oncogenes, signal transduction, surface antigens and transcription factor molecular markers; and then
correlating (1) the presence or amount of said molecular markers and, with (2), clinicopathological data from said tissue sample other than the molecular markers of breast cancer disease processes, in order to deduce a probability of response to adjuvant therapy or future risk of disease progression in breast cancer for the subject.

2. The method according to claim 1 wherein the correlating is in order to deduce a probability of response to a specific adjuvant therapy drawn from the group consisting of
chemotherapeutic agents consisting essentially of 5-Fluorouracil, vinblastine, gemcitabine, methotrexate, goserelin, irinotecan, thiotepa, and topotecan;
aromatase inhibitors i consisting essentially of exomestane, anastrazole, and letrozole;
anti-estrogens consisting essentially of tamoxifen, fluvestrant, raloxifene, megestrol, and toremifene
taxanes consisting essentially of paclitaxol and docetaxel;
antracyclines consisting essentially of doxurubicin and cyclophosphamide; chemotherapy combinations such as doxurubicin, cyclophosphamide, ocovorin, prednisone; and
targeted agents consisting essentially of lapitinab, bevacizumab, trastuzumab, cetuximab, or panitumumab.

3. The method according to claim 1 wherein the correlating comprises:
determining the expression levels of one or more proteomic marker(s) and the numerical quantity of one or more clinicopathological marker(s) from breast cancer test sample excised from a patient population P1 before therapeutic treatment, clinical outcome C1 after a certain time period on said patient population P1 not known in advance;
comparing said determined levels and numerical values to another set of expression levels of one or more proteomic marker(s) and the numerical quantity of one or more clinicopathological marker(s) from breast cancer test sample excised from a separate patient population P2 before therapeutic treatment, clinical outcome C2 after said certain time period on said patient population P2 known in advance;
wherein the clinical outcome C1 and C2 is drawn from the group consisting essentially of: breast cancer disease diagnosis, disease prognosis, or treatment outcome or a combination of any two, three or four of these outcomes; and
training an algorithm to identify characteristic expression levels of one or more proteomic marker(s) and numerical quantity(ies) of one or more clinicopathological marker(s) between said patient population P1 and patient population P2 which correlate to clinical outcome C1 and clinical outcome C2, respectively.

4. The method according to claim 3 wherein the training of the algorithm on characteristic protein levels or patterns of differences includes the steps of
obtaining numerous examples of (i) said expression levels of one or more proteomic marker(s) and numerical quantity(ies) of one or more clinicopathological marker(s) data, and (ii) historical clinical results corresponding to this proteomic marker(s) and clinicopathological marker(s) data;
constructing an algorithm suitable to map (i) said characteristic proteomic and said clinicopathological marker(s) data values as inputs to the algorithm, to (ii) the historical clinical results as outputs of the algorithm;
exercising the constructed algorithm to so map (i) the said protein expression levels and clinicopathological marker(s) values as inputs to (ii) the historical clinical results as outputs; and
conducting an automated procedure to vary the mapping function inputs to outputs, of the constructed and exercised algorithm in order that, by minimizing an error measure of the mapping function, a more optimal algorithm mapping architecture is realized;
wherein realization of the more optimal algorithm mapping architecture, also known as feature selection, means that any irrelevant inputs are effectively excised, meaning that the more optimally mapping algorithm will substantially ignore specific proteomic marker(s) and specific clinicopathological marker(s) values that are irrelevant to output clinical results; and
wherein realization of the more optimal algorithm mapping architecture, also known as feature selection, also means that any relevant inputs are effectively identified, making that the more optimally mapping algorithm will serve to identify, and use, those input protein expression levels or mass spectrometry peak or mass-to-charge ratio(s) and said clinicopathological marker(s) values that are relevant, in combination, to output clinical results that would result in a clinical detection of disease, disease diagnosis, disease prognosis, or treatment outcome or a combination of any two, three or four of these actions.

5. The method according to claim 4 wherein the constructed algorithm is drawn from the group consisting essentially of: as determined in accordance with a look-up table, linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; a plurality of algorithms arranged in a committee network; and forward floating search or backward floating search algorithms.

6. The method according to claim 4 wherein the feature selection process employs an algorithm drawn from the group consisting essentially of: linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; recursive feature elimination or entropy-based recursive feature elimination algorithms; a plurality of algorithms arranged in a committee network; and forward floating search or backward floating search algorithms.

7. The method according to claim 4 wherein a tree algorithm is trained to reproduce the performance of another machine-learning classifier or regressor by enumerating the input space of said classifier or regressor to form a plurality of training examples sufficient (1) to span the input space of said classifier or regressor and (2) train the tree to emulate the performance of said classifier or regressor.

8. The method according to claim 2
wherein the correlating so as to predict the response to adjuvant therapy or disease progression is particularly so as to predict the response to chemotherapy or tumor aggressiveness respectively;
and wherein the method further comprises:
diagnosing breast cancer in a patient by taking a biopsy of breast cancer tissue and identifying that said biopsy is wholly or partially malignant;
identifying clinicopathological values associated with said malignant biopsy;
analyzing said malignant tissue for the proteomic markers ER, PGR, ERBB2, TP-53, BCL-2, CDKN1B, and EGFR by immunohistochemistry and c-MYC gene amplification, and one or more additional proteomic markers;
evaluating the patient's prediction of response of said tumor to said therapy or evaluated risk of disease progression, respectively from said measured levels of proteomic markers and clinicopathological values; and
administering chemotherapy or other therapy as appropriate to the evaluated prediction of response of said tumor to said therapy or evaluated risk of disease progression, respectively.

9. The method according to claim 8 wherein the one or more additional proteomic markers includes, in addition to markers ER, PGR, ERBB2, TP-53, BCL-2, CDKN1B, and EGFR by immunohistochemistry and c-MYC gene amplification, one or more of the markers selected from the group consisting of
PLAU, CAV1, Ki-67 and MTA1.

10. The method of claim 8
wherein the correlating is further so as to determine breast cancer treatment or prognostic outcome; and
wherein the correlating is performed in accordance with an algorithm drawn from the group consisting essentially of: as determined in accordance with a look-up table, linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; recursive feature elimination or entropy-based recursive feature elimination algorithms; a plurality of algorithms arranged in a committee network; and forward floating search or backward floating search algorithms.

11. The method of claim 10 wherein the correlating so as to further determine breast cancer treatment outcome is, in addition to prediction of response to chemotherapy, expanded to prediction of response to a targeted therapy.

12. The method of claim 1 wherein correlating is of clinicopathological data selected from a group consisting of
Adjuvant! Online score, tumor nodal status, tumor grade, tumor size, tumor location, patient age, previous personal and/or familial history of breast cancer, previous personal and/or familial history of response to breast cancer therapy, and BRCA1&2 status.

13. The method of claim 1
wherein the molecular markers of estrogen receptor status are ER and PGR, the molecular markers of growth factor receptors are ERBB2, the tumor suppression molecular markers are TP-53 and BCL-2; and the cell cycle molecular marker is CDKN1B, and the marker of proliferation is CAV-1;
wherein the additional one or more molecular marker(s) is selected from the group consisting of essentially: of c-MYC gene amplification, EGFR, and KI-67;
wherein the clinicopathological data is one or more datum values selected from the group consisting essentially of: Adjuvant! Online score, tumor size, nodal status, and grade;
wherein the correlating is by usage of a trained kernel partial least squares algorithm; and
wherein the prediction is of time to recurrence when treated for breast cancer with a chemotherapeutic agent.

14. The method of claim 13
wherein the additional one or more molecular marker(s) is c-MYC gene amplification; and
wherein the chemotherapeutic agent is 5-Fluorouracil-based combination chemotherapy.

15. The method of claim 1
wherein the molecular markers of estrogen receptor status are ER and PGR, the molecular markers of growth factor receptors are ERBB2, the tumor suppression molecular markers are TP-53 and BCL-2; and
wherein the cell cycle molecular marker is CDKN1B, and the marker of proliferation is CAV-1;
wherein and the additional one or more molecular marker(s) is selected from the group consisting of essentially of c-MYC gene amplification, EGFR, pT4, LVI, PLAU, and TIMP1, and KI-67;
wherein the clinicopathological data is one or more datum values selected from the group consisting essentially of: Adjuvant! Online score, tumor size, nodal status, and grade; and
wherein the correlating is by usage of a trained kernel partial least squares algorithm; and the prediction is of risk of breast cancer progression.

16. A method of predicting a DCIS-type breast cancer from a LCIS-type breast cancer comprising:
examining the expression level of CAV-1 and one or more additional cancer markers;
wherein the protein expression level of CAV-1 and one or more other cancer markers are measured by immunohistochemistry; and
interpreting a high level of expression of CAV-1 to be that the breast cancer is of the DCIS or LCIS type.

17. A kit comprising:
a panel of antibodies, a binding of each which with breast cancer tumor samples has been correlated with breast cancer treatment outcome or patient prognosis;
one or more gene amplification assays corresponding to genes an amplification of which has been correlated with breast cancer treatment outcome or patient prognosis or both treatment outcome or patient prognosis;
first reagents to assist said antibodies with binding to tumor samples; and
second reagents to assist in determining gene amplification for said genes the amplification of which has been correlated;
wherein the panel of antibodies, the one or more gene amplification assays, the first reagents and the second reagents can be applied to a breast cancer patient's tumor tissue sample;
wherein the application of said reagents and assays permits observation, and determination, of a numerical level of expression of each individual antibody, and gene amplification, upon the breast cancer patient's tumor tissue sample; and
wherein a computer algorithm, residing on a computer, calculates in consideration of determined levels of expression for antibodies and the amplified genes, as well as previously-determined clinicopathological data from the tumor and patient such as size, grade, and nodal status, a prediction of treatment outcome for a specific treatment for breast cancer, or future risk of breast cancer progression, or both specific treatment and future risk of breast cancer progression for the patient from whom the breast cancer tumor sample was obtained

18. The kit according to claim 17 wherein the panel of antibodies comprises:
a poly- or monoclonal antibody specific for an individual protein or protein fragment and that binds one of said antibodies correlated with breast cancer treatment outcome or patient prognosis.

19. The kit according to claim 17 further comprising:
a number of immunohistochemistry assays equal to the number of antibodie; and
a number of gene amplification assays equal to the number of amplified genes.

20. The kit according to claim 17 wherein the antibodies are antibodies correlated with breast cancer treatment outcome, the gene amplification assays are for genes whose amplification is correlated with breast cancer treatment outcome, and the computer algorithm is an algorithm using kernel partial least squares or that is determined in accordance with a look-up table.

21. The kit according to claim 20 wherein the antibodies consist essentially of
antibodies specific to ER, PGR, ERBB2, TP-53, BCL-2, CDKN1B, EGFR, Ki-67 and CAV-1; and
wherein the gene amplification assay is for c-MYC.

22. The kit according to claim 20 wherein the predicted treatment outcome is responsive to targeted therapy or chemotherapy.

23. An anti-breast-breast-cancer-tumor drug consisting essentially of
a monoclonal antibody directed against expression of stromal CAV-1 tumor cells with the purpose of preventing invasion of a tumor into surrounding normal tissue or otherwise restricting the tumor's growth.
